(19) United States
(12) Patent Application Publication
(10) Pub. No.: US 2008/0169746 A1
(43) Pub. Date: Jul. 17, 2008

(54) BULB FOR LIGHT-EMITTING DIODE

(75) Inventor: George R. Hulse, Arlington Heights, IL (US)

Correspondence Address: STITES & HARBISON, PLLC, 400 W MARKET ST, SUITE 1800, LOUISVILLE, KY, 40202-3352, US

(73) Assignee: ILIGHT TECHNOLOGIES, INC., Chicago, IL (US)

(21) Appl. No.: 11/945,691

(22) Filed: Nov. 27, 2007

Related U.S. Application Data
(60) Provisional application No. 60/884,638, filed on Jan. 12, 2007.

(51) Int. Cl. H01J 1/62

(52) U.S. Cl. 313/483

(57) ABSTRACT

A bulb is adapted to fit over a light-emitting diode emitting a light of a first hue. The bulb has a generally spherical shape and defines an external surface, and the bulb is composed of an acrylic resin and a light color-converting material. The light color-converting material converts the light of the first hue into light of a desired hue, which is then observed over the external surface of said bulb.

### CROSS-REFERENCE TO RELATED APPLICATIONS

The present application claims priority to U.S. Provisional Patent Application Ser. No. 60/884,638 filed on Jan. 12, 2007, the entire disclosure of which is incorporated herein by reference.

### BACKGROUND OF THE INVENTION

The present invention is a bulb that fits over an LED, converting the light emitted from the LED into light of a desired hue, which is then observed over the external surface of the bulb.

Light-emitting diodes (LEDs) are now commonly used for a wide variety of general illumination and special effects illumination. For example, commonly assigned U.S. Pat. Nos. 6,592,238; 6,953,262; and 7,188,970, which are incorporated in their entirety herein by this reference, each describe an illumination device for simulating neon lighting having a plurality of spaced LEDs positioned adjacent the light-receiving surface of a rod-like member or waveguide. The rod-like member/waveguide is made of a material that preferentially scatters light entering the light-receiving surface such that the light intensity pattern exiting a light-emitting surface of the rod-like member/waveguide is substantially uniform.

Nevertheless, the available visible color spectrum for illumination devices that use LEDs is limited by the finite availability of LED colors. Therefore, in commonly assigned U.S. Pat. Nos. 7,011,421; 7,264,366; and 7,264,367, each of which is also incorporated herein by this reference, illumination devices are described that use LEDs in conjunction with fluorescent and/or phosphorescent dyes, allowing for the emission of light in hues that cannot ordinarily be achieved through the use of LEDs alone.

### SUMMARY OF THE INVENTION

The present invention is a bulb that fits over an LED, converting the light emitted from the LED into light of a desired hue, which is then observed over the external surface of the bulb.

An exemplary bulb made in accordance with the present invention is composed of a light-transmitting material and a light color-converting material. This exemplary bulb has a generally spherical shape, which results in a substantially circular cross-sectional geometry, and fits over an LED. A suitable light-transmitting material is a translucent acrylic resin that scatters light as it passes through the material, so that a substantially uniform light intensity pattern is observed over the external surface of the exemplary bulb. The light color-converting material is some predetermined combination of one or more fluorescent dyes, phosphorescent dyes, and/or other dyes or colorants that are mixed into the light-transmitting material. When the exemplary bulb is fit over an LED, the LED emits light of a first hue into the bulb. The light color-converting material in the exemplary bulb converts the light of the first hue into light of a desired hue, which is then observed over the external surface of the bulb.

### DESCRIPTION OF THE DRAWINGS

FIG. 1 is a perspective view of an exemplary bulb made in accordance with the present invention;

FIG. 1A is a sectional view of the exemplary bulb of FIG. 1, taken along line 1A-1A of FIG. 1; and

FIG. 2 is a block diagram illustrating the passage of light through the exemplary bulb of FIGS. 1 and 1A.

### DETAILED DESCRIPTION OF THE INVENTION

The present invention is a bulb that fits over an LED, converting the light emitted from the LED into light of a desired hue, which is then observed over the external surface of the bulb.

For purposes of the discussion that follows, it is important to recognize that most perceived “colors” are not representative of light of a single wavelength, but rather some combination of wavelengths. In this regard, the dominant or perceived color of light comprised of some combination of wavelengths is generally referred to as hue. In order to provide a mechanism to represent and identify all possible perceived colors, the Commission Internationale l'Eclairage (CIE) constructed the CIE Chromaticity Diagram, which is based on three ideal primary light colors of red, green, and blue. The CIE Chromaticity Diagram is a well-known tool for identifying colors and is well understood by one of ordinary skill in the art. Specifically, since the x-axis of this CIE Chromaticity Diagram represents the amount of ideal red that would be mixed with ideal blue, and the y-axis of the CIE Chromaticity Diagram represents the amount of ideal green that would be mixed with ideal blue, a desired color can be identified in terms of its x and y coordinates. It is also important to recognize that the chromaticity curve, which is representative of the visible spectrum, is commonly superimposed over the chart such that wavelengths within the visible spectrum are represented along this curve.

Furthermore, the CIE Chromaticity Diagram is also helpful in understanding mixtures of primary light colors. Specifically, if a straight line is drawn between two points on the chromaticity curve, for example from green with a wavelength of 510 nm to red with a wavelength of 700 nm, that straight line illustrates the range of colors that could be created and perceived by the human eye, depending on the relative amounts of primary light colors in the mixture, including various yellowish-green colors and oranges. It is also important to recognize that the central region of the CIE Chromaticity Diagram is representative of white, a combination of the three ideal primary light colors. If any straight line between two colors on the chromaticity curve passes through this central region, those two colors can be mixed to create a perceived white color.

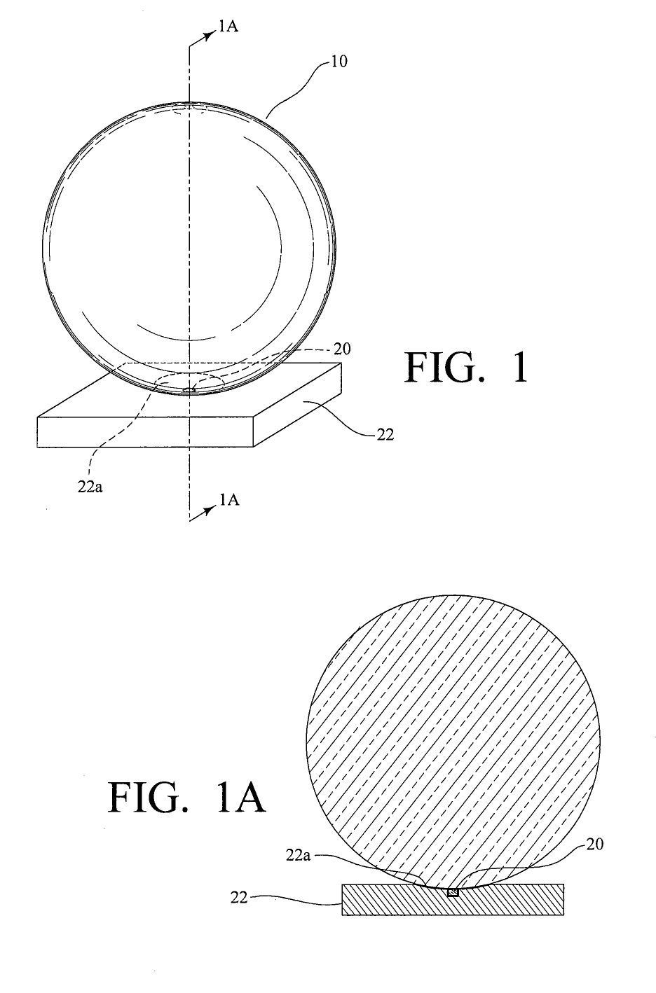

Returning to the present invention, and referring to FIGS. 1 and 1A, an exemplary bulb 10 made in accordance with the present invention is composed of a light-transmitting material and a light color-converting material. This exemplary bulb 10 has a generally spherical shape, which results in a substantially circular cross-sectional geometry. This exemplary bulb 10 fits over an LED 20, as will be further described below.

Applicant has discovered that a suitable light-transmitting material is a translucent acrylic resin, for example, Plexiglas® Frosted DR-66080 White TL, manufactured and distributed by Arkema, Inc. of Puteaux, France and Philadelphia, Pa. (Plexiglas® is a registered trademark of Arkema, Inc.). This particular material has an inherent haze value (i.e., a measure of the scattering of light as it passes through the material) of approximately 98% according to American Society for Testing Materials (ASTM) Test Method D1003.

When using such an acrylic resin, the light color-converting material may be some predetermined combination of one or more fluorescent dyes, phosphorescent dyes, and/or other dyes or colorants that are mixed into the light-transmitting material. For example, suitable fluorescent dyes include Lumogen™ F240 (orange), Lumogen™ F170 (yellow), Lumogen™ F285 (pink), and Lumogen™ 850 (green), each of which may be acquired from BASF Corporation of Mount Olive, N.J. Since these dyes are typically manufactured and distributed in powdered form, the dyes can be mixed with pellets of the acrylic resin in an appropriate ratio. The mixture is then preferably dried for removal of moisture, and the mixture can then be molded into the desired geometry.

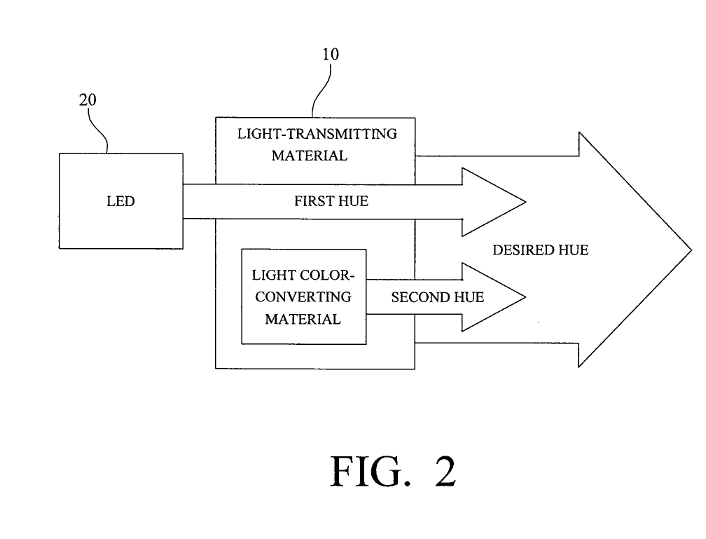

Referring still to FIGS. 1, 1A and 2, when the exemplary bulb 10 is fit over an LED 20, the LED 20 emits light of a first hue into the bulb 10. The light color-converting material in the bulb 10 converts the light of the first hue into light of a desired hue, which is then observed over the external surface of the bulb 10. In this regard, the hue of the light observed over the external surface of the bulb 10 is usually some combination of the light of the first hue (directly from the LED 20) and the hue of the light emitted from light color-converting material (i.e., as second hue). In other words, unless all of the light emitted directly from the LED 20 is absorbed by the light color-converting material of the bulb 10, some of the light emitted directly from the LED 20 will continue through the bulb such that the observed light is a combination of the light of the first hue (from the LED 20) and the light of the second hue (from the light color-converting material). For example, the LED 20 may emit light having a wavelength in the blue region (short wavelength and relatively high energy) of the color spectrum, and the light color-converting material may be an orange fluorescent dye, such that the mixed light approximates the hue and intensity of a conventional tungsten filament light source, i.e., the desired hue is white.

Referring still to FIGS. 1, 1A and 2, Applicant has determined that one appropriate LED for use with the bulb 10 of the present invention is a 470-nm (blue) light-emitting diode distributed by Marktech Optoelectronics of Latham, N.Y. under part number LP9K03-B3. When using this particular LED in conjunction with a bulb 10 made from Plexiglas® Frosted DR-66080 White TL (referenced above) having a generally spherical shape with a diameter of approximately 12 mm, a substantially uniform light intensity pattern is observed over the external surface of the bulb 10. Furthermore, by using an orange fluorescent dye, such as Lumogen™ F240 (also referenced above), the blue light emitted from the LED 20 can be converted into a white light, with a substantially uniform light intensity pattern then being observed over the external surface of the bulb 10.

Furthermore, as illustrated in FIGS. 1 and 1A, in this exemplary embodiment, the LED 20 is supported on a circuit board 22 in a small hemispherical depression 22a defined by the circuit board 22. As such, the bulb 10 rests in the hemispherical depression 22a. Of course, the bulb 10 may be adhered to the LED 20 or otherwise secured over the LED 20 without departing from the spirit and scope of the present invention.

As a further refinement with respect to the exemplary bulb 10 discussed above, the external surface of the bulb 10 could be roughened, stippled, or otherwise provided with a scattering material to disrupt or prevent a lensing effect at the surface as light exits the bulb 10.

One of ordinary skill in the art will recognize that additional embodiments are possible without departing from the teachings of the present invention or the scope of the claims which follow. This detailed description, and particularly the specific details of the exemplary embodiment disclosed herein, is given primarily for clarity of understanding, and no unnecessary limitations are to be understood therefrom, for modifications will become obvious to those skilled in the art upon reading this disclosure and may be made without departing from the spirit or scope of the claimed invention.

What is claimed is:

1. A bulb adapted to fit over a light-emitting diode emitting a light of a first hue, said bulb having a generally spherical shape and defining an external surface, and said bulb being composed of an acrylic resin and a light color-converting material, said light color-converting material converting the light of the first hue into light of a desired hue, which is then observed over the external surface of said bulb.

2. The bulb as recited in claim 1, wherein said light color-converting material is one or more fluorescent dyes mixed into said acrylic resin.

3. The bulb as recited in claim 1, wherein said light color-converting material is one or more phosphorescent dyes mixed into said acrylic resin.

4. The bulb as recited in claim 1, wherein said light color-converting material is a combination of fluorescent dyes and/or phosphorescent dyes mixed into said acrylic resin.

5. A bulb adapted to fit over a light-emitting diode emitting a light of a first hue, said bulb having a generally spherical shape and defining an external surface, and said bulb being composed of an acrylic resin and a light color-converting material, said light color-converting material converting the light of the first hue into light of a desired hue, with a substantially uniform light intensity pattern of the desired hue then being observed over the external surface of said bulb.

6. A lighting assembly, comprising:
a light-emitting diode emitting a light of a first hue; and
a bulb adapted to fit over the light-emitting diode, said bulb having a generally spherical shape and defining an external surface, and said bulb being composed of an acrylic resin and a light color-converting material, said light color-converting material converting the light of the first hue into light of a desired hue, which is then observed over the external surface of said bulb.
